(19) United States
(12) Patent Application Publication
(10) Pub. No.: US 2011/0145557 A1
(43) Pub. Date: Jun. 16, 2011

(54) OPERATING SYSTEM FOR STARTING COMPUTER AND METHOD THEREOF

(75) Inventors: XIAO-GUANG LI, Shenzhen City (CN); GUO-FEI ZHANG, Shenzhen City (CN); XIN ZHAO, Shenzhen City (CN); RUEY-SHYANG YOU, Tu-Cheng (TW); HAN-CHE WANG, Tu-Cheng (TW); KUAN-HONG HSIEH, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/778,137

(22) Filed: May 12, 2010

(30) Foreign Application Priority Data
Dec. 15, 2009 (CN) 200910311481.7

(51) Int. Cl. G06F 15/177

(52) U.S. Cl. 713/1

(57) ABSTRACT

A method for starting a computer is provided. The method includes: initializing a CPU, a storage unit, a display, and the remaining hardware of the computer. Obtaining provided Internet guide information and opening at least one application according to the Internet guide information once the CPU, the storage unit, and the display have been initialized. Displaying the interface of the at least one opened application according to a default display format. A related system is also provided.

### BACKGROUND

1. Technical Field

The present disclosure relates to operating systems for starting computers and methods thereof and, particularly, to an operating system capable of showing an non-boot-up interface when the computer is powered on and a method thereof.

2. Description of Related Art

Commonly, during boot up of computers, users cannot view any interface or input any information into the computers except for entering and viewing the BIOS or a test interface. For some computers the boot time feels too long, thus the users may feel bored and become impatient during the boot up process.

### BRIEF DESCRIPTION OF THE DRAWINGS

The components of the drawings are not necessarily drawn to scale, the emphasis instead being placed upon clearly illustrating the principles of an operating system for starting a computer and a method thereof. Moreover, in the drawings, like reference numerals designate corresponding parts throughout several views.

FIG. 1 is a block diagram showing a computer and an operating system in accordance with an exemplary embodiment.

FIG. 2 is a block diagram of the operating system of FIG. 1.

FIG. 3 is a schematic view showing a user interface.

FIG. 4 is a schematic view showing an opened interface.

FIG. 5 is a flowchart of a method for starting a computer in accordance with an exemplary embodiment.

### DETAILED DESCRIPTION

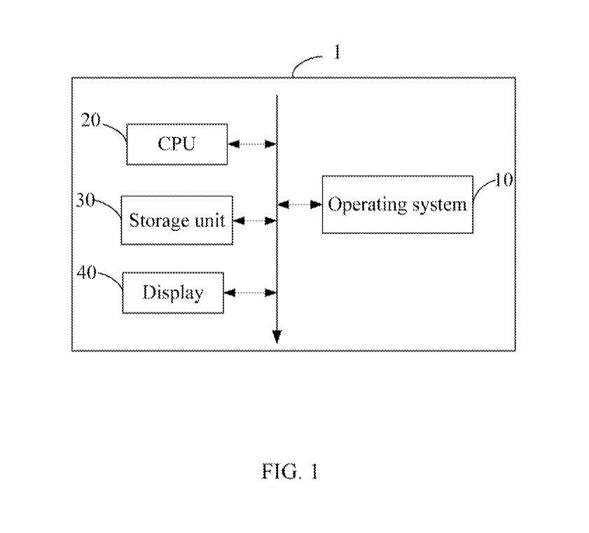

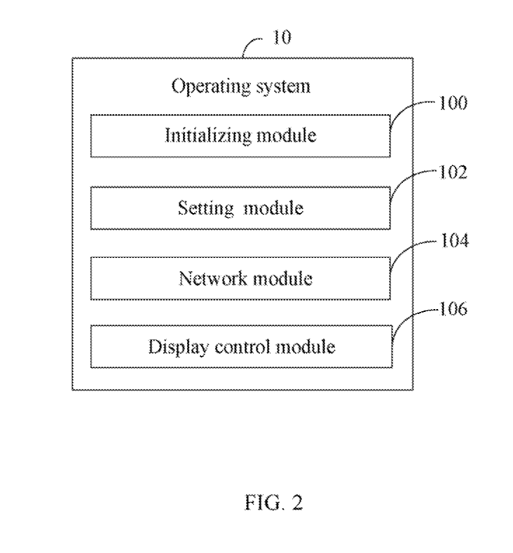

Referring to FIGS. 1-2, an operating system 10 is applied in a computer 1 for starting the computer 1. The computer 1 includes a central processing unit (CPU) 20, a storage unit 30, and a display 40. The operating system 10 includes an initializing module 100, a setting module 102, a network module 104, and a display control module 106.

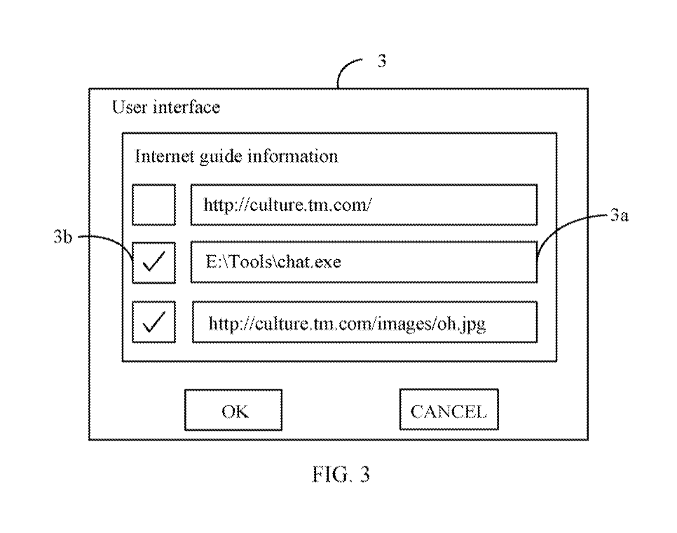

Referring also to FIG. 3, the setting module 102 is configured to display a user interface 3 to set Internet guide information after booting up the computer 1. The Internet guide information includes website universal resource locaters (URLs) and access paths for instant messaging software. In the embodiment, the user interface 3 includes at least one input box 3a and at least one check box 3b. Each of the input boxes 3a corresponds to one check box 3b. The input boxes 3a are for the users to input the website URLs and the access paths. When the users input one of the website URLs or one of the access paths and select the corresponding check box 3b, the input website URL or the instant messaging software will be activated during boot up of the computer.

The initializing module 100 is configured for initializing the CPU 20, the storage unit 30, and the display 40 when the computer 1 is powered on. The initializing module 100 is further configured for initializing the remaining hardware (not shown) of the computer 1.

The network module 104 is configured for obtaining the Internet guide information and navigating to websites and/or instant messaging software according to the Internet guide information when the initializing module 100 initializes the CPU 20, the storage unit 30, and the display 40.

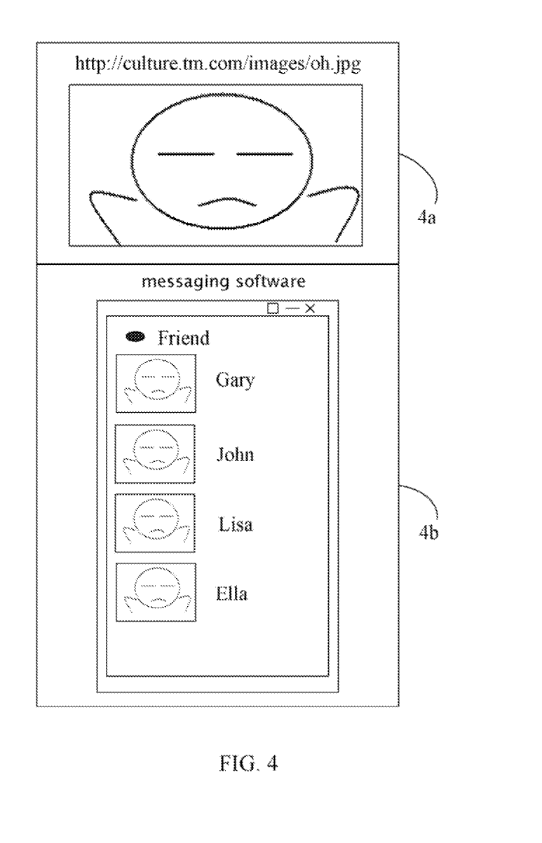

The display control module 106 is configured to display the opened webpage and the interface of the opened instant messaging software on the display 40 according to a default display format. For example, referring to FIG. 4, the display control module 106 displays an opened webpage in a first display area 4a and displays the interface of the opened messaging software in the second display area 4b.

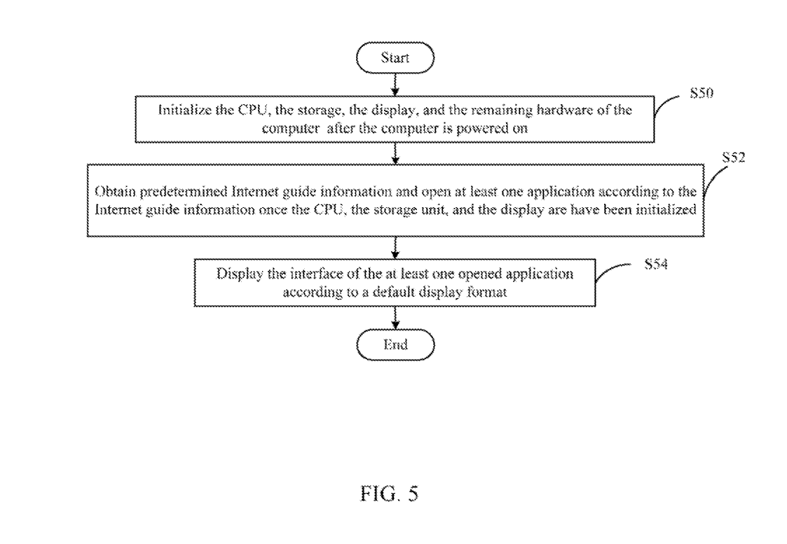

FIG. 5 is a flowchart of a method for starting the computer 1 using the operating system 10. In step S50, the initializing module 100 initializes the CPU 20, the storage unit 30, the display 40, and the other hardware of the computer 1 after the computer 1 is powered on.

In step S52, the network module 104 obtains the Internet guide information and navigates to a selected website and/or opens instant messaging software once the initializing module 100 has initialized the CPU 20, the storage unit 30, and the display 40.

In step S54, the display control module 106 displays the opened webpage and/or the interface of the opened instant messaging software on the display 40 according to a default display format.

As described above, the operating system 10 can provide an available interface during the time of booting up the computer, thus providing some functionality to the users without incurring user boredom or impatience.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An operating system for starting a computer, the operating system comprising:
an initializing module configured to initialize a CPU, a storage unit, a display, and the remaining hardware of the computer when the computer is powered on;
a setting module configured to display a user interface for setting Internet guide information;
a network module configured to obtain the Internet guide information and open an application according to the obtained Internet guide information once the initializing module has initialized the CPU, the storage unit, and the display; and
a display control module configured, during boot up of the computer, to display the interface of the opened application on the display according to a default display format.

2. The operating system as claimed in claim 1, wherein the user interface includes at least one input box and at least one check box, and each of the input boxes corresponds to one check box.

3. The operating system as claimed in claim 1, wherein the user interface comprises at least one website URLs.

4. The operating system as claimed in claim 1, wherein the user interface comprises at least one access path of at least one instant messaging software.

5. A method for starting a computer, the method comprising:
initializing a CPU, a storage unit, a display, and the remaining hardware of the computer;
obtaining predetermined Internet guide information and opening at least one application according to the Internet guide information once the CPU, the storage unit, and the display have been initialized; and
displaying the interface of the at least one opened application according to a default display format during boot up of the computer.

6. The method as claimed in claim 5, wherein the Internet guide information comprises at least one website URLs.

7. The method as claimed in claim 5, wherein the Internet guide information comprise at least one access path of at least one instant messaging software.
